(19) United States
(12) Patent Application Publication
(10) Pub. No.: US 2026/0155508 A1
(43) Pub. Date: Jun. 4, 2026

(54) SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/342,851

(22) Filed: Sep. 29, 2025

(30) Foreign Application Priority Data
Dec. 3, 2024 (KR) 10-2024-0177613

(51) Int. Cl. H01M 50/169; H01M 10/052; H01M 50/103; H01M 50/15

(52) U.S. Cl. CPC H01M 50/169; H01M 10/052; H01M 50/103; H01M 50/15

(57) ABSTRACT

A secondary battery includes an electrode assembly including a first electrode, a second electrode, and a separator, a case body accepting the electrode assembly through one opened side surface and including a first binding surface formed along a circumference of the one opened side surface, and a case cover bound to the one opened side surface of the case body and including a second binding surface formed along a circumference of the case cover such that the second binding surface is able to tightly bind to the first binding surface. At least a part of the first binding surface and the second binding surface are inclined.

### CROSS-REFERENCE TO RELATED APPLICATION

The present application claims priority to and the benefit of Korean Application No. 10-2024-0177613, filed on Dec. 3, 2024, in the Korean Intellectual Property Office, the entire disclosure of which is incorporated by reference herein.

### BACKGROUND

### Field

The present disclosure relates to a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery using a case made of a metal material may be manufactured by binding one opened side surface of a case body with a case cover and sealing the case cover onto the case by welding. An electrode assembly and an electrolyte may be housed in the case body. However, cracks may occur on a welded surface of the case body and/or the case cover, a problem deteriorating performance and safety of the secondary battery.

The above information disclosed in this Background section is for enhancement of understanding of the background of the present disclosure, and therefore, it may contain information that does not constitute related (or prior) art.

### SUMMARY

The present disclosure provides a secondary battery to resolve the problem described above.

These and other aspects and features of the present disclosure will be described in or will be apparent from the following description of embodiments of the present disclosure.

According to some embodiments of the present disclosure, a secondary battery may include an electrode assembly including a first electrode, a second electrode, and a separator, a case body accommodating the electrode assembly and including a first binding surface formed along a circumference of the one opened side surface, and a case cover bound to the opened side surface of the case body and including a second binding surface formed along a circumference of the case cover, with the second binding surface may be bound to the first binding surface. At least a part of the first binding surface and the second binding surface may be inclined.

In some embodiments, the first binding surface may include a first inclined surface inclined at a predetermined angle with respect to a bottom surface of the case body in a first direction parallel to the case cover. The second binding surface may include a second inclined surface formed with a same angle and a same size as those of the first inclined surface.

In some embodiments, an angle of the first inclined surface may be more than 0 degrees and less than or equal to 60 degrees with respect to the bottom surface of the case body in the first direction.

In some embodiments, the first inclined surface may be convex or concave. The second inclined surface may be of a shape corresponding to the first inclined surface so that the second inclined surface may be able to be tightly in contact with the first inclined surface.

In some embodiments, the first binding surface may include a first horizontal surface parallel to the first direction, the first inclined surface extends toward the bottom surface of the case body from the first horizontal surface, and the second binding surface may include the second inclined surface, which may be tightly in contact with the first inclined surface.

In some embodiments, a length of the first horizontal surface may be 1% to 10% of a thickness of the case body.

In some embodiments, the first binding surface may include a first outer horizontal surface parallel to the first direction and a first inner horizontal surface, which extends parallel to the first direction from the first inclined surface and on which an inner circumferential surface of the case cover settles. The first inclined surface extends toward the bottom surface of the case body from the first outer horizontal surface, and the second binding surface may include the second inclined surface, which may be tightly in contact with the first inclined surface.

In some embodiments, a length of the first outer horizontal surface may be 1% to 10% of a thickness of the case body, and a length of the first inner horizontal surface may be 10% to 20% of the thickness of the case body.

In some embodiments, the first binding surface may include a first outer horizontal surface parallel to the first direction, a first vertical surface extending in a direction orthogonal to the first outer horizontal surface, and a first inner horizontal surface, which extends parallel to the first direction from the first inclined surface and on which an inner circumferential surface of the case cover settles. The first inclined surface extends toward the bottom surface of the case body from the first vertical surface, the second binding surface may include a second vertical surface tightly in contact with the first vertical surface, and the second inclined surface extends from the second vertical surface and may be tightly in contact with the first inclined surface.

In some embodiments, a length of the first outer horizontal surface may be 1% to 10% of a thickness of the case body, a length of the first vertical surface may be 1% to 20% of a thickness of the case cover, and a length of the first inner horizontal surface may be 10% to 20% of the thickness of the case body.

In some embodiments, the second binding surface may include a second vertical surface orthogonal to the first direction, the second inclined surface extends toward the bottom surface of the case body from the second vertical surface, and the first inclined surface may be tightly in contact with the second inclined surface.

In some embodiments, a length of the second vertical surface may be 1% to 20% of a thickness of the case cover.

In some embodiments, the second binding surface may include a second vertical surface orthogonal to the first direction, the second vertical surface extends toward the bottom surface of the case body from the second vertical surface, the first inclined surface may be tightly in contact with the second inclined surface, and the first binding surface may include a first horizontal surface, which extends parallel to the first direction from the first inclined surface and on which an inner circumferential surface of the case cover settles.

In some embodiments, a length of the second vertical surface may be 1% to 20% of a thickness of the case cover, and a length of the first horizontal surface may be 10% to 20% of a thickness of the case body.

In some embodiments, the second binding surface may include a second vertical surface orthogonal to the first direction and a second horizontal surface extending parallel to the first direction from the second vertical surface. The second inclined surface extends toward the bottom surface of the case body from the second horizontal surface. The first binding surface may include a first outer horizontal surface parallel to the first direction and tightly in contact with the second horizontal surface and a first inner horizontal surface, which extends parallel to the first direction from the first inclined surface and on which an inner circumferential surface of the case cover settles. The first inclined surface extends toward the bottom surface of the case body from the first outer horizontal surface and may be tightly in contact with the second inclined surface.

In some embodiments, a length of the second vertical surface may be 1% to 20% of a thickness of the case cover, a length of the first outer horizontal surface may be 1% to 10% of a thickness of the case body, and a length of the first inner horizontal surface may be 10% to 20% of the thickness of the case body.

In some embodiments, the second binding surface may include a second vertical surface orthogonal to the first direction. The second inclined surface extends toward the bottom surface of the case body from the second vertical surface. The first binding surface may include a first horizontal surface parallel to the first direction. The first inclined surface extends toward the bottom surface of the case body from the first horizontal surface and may be tightly in contact with the second inclined surface.

In some embodiments, a length of the second vertical surface may be 1% to 20% of a thickness of the case cover, and a length of the first horizontal surface may be 1% to 10% of a thickness of the case body.

In some embodiments, the second binding surface may include a second vertical surface orthogonal to the first direction. The second inclined surface extends toward the bottom surface of the case body from the second vertical surface. The first binding surface may include a first outer horizontal surface parallel to the first direction and a first inner horizontal surface, which extends parallel to the first direction from the first inclined surface and on which an inner circumferential surface of the case cover settles. The first inclined surface extends toward the bottom surface of the case body from the first outer horizontal surface and may be tightly in contact with the second inclined surface.

In some embodiments, a length of the second vertical surface may be 1% to 20% of a thickness of the case cover, a length of the first outer horizontal surface may be 1% to 10% of a thickness of the case body, and a length of the first inner horizontal surface may be 10% to 20% of the thickness of the case body.

According to some embodiments of the present disclosure, it is possible to ensure excellent welding characteristics by forming an inclined surface on a bound surface where a case body and a case cover of a secondary battery are welded together.

According to some embodiments of the present disclosure, it is possible to improve welding characteristics of the case body and the case cover of the secondary battery and to prevent a crack from occurring on a welded surface thereof, which may deteriorate performance and safety of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according some embodiments of the present disclosure.

FIG. 2 is a cross-sectional view of binding surfaces of a case body and a case cover, which are separated, of the secondary battery according to some embodiments of the present disclosure, showing section A-A of FIG. 1.

FIG. 3 is a cross-sectional view of the binding surfaces of the case body and the case cover of the secondary battery of FIG. 2 according to some embodiments of the present disclosure.

FIG. 4 is a cross-sectional view of inclined binding surfaces of a case body and a case cover of a secondary battery according to some embodiments of the present disclosure.

FIG. 5 is a cross-sectional view of binding surfaces of a case body and a case cover, which are separated, of a secondary battery according to some embodiments of the present disclosure, showing section A-A of FIG. 1.

FIG. 6 is a cross-sectional view of the binding surfaces of the case body and the case cover of the secondary battery of FIG. 5 according to some embodiments of the present disclosure.

FIG. 7 is a cross-sectional view of inclined binding surfaces of a case body and a case cover of a secondary battery according to some embodiments of the present disclosure.

FIG. 8 is a cross-sectional view of binding surfaces of a case body and a case cover, which are separated, of a secondary battery according to some embodiments of the present disclosure, showing section A-A of FIG. 1.

FIG. 9 is a cross-sectional view of the binding surfaces of the case body and the case cover of the secondary battery of FIG. 8 according to some embodiments of the present disclosure.

FIG. 10 is a cross-sectional view of inclined binding surfaces of a case body and a case cover of a secondary battery according to some embodiments of the present disclosure.

FIG. 11 is a cross-sectional view of binding surfaces of a case body and a case cover, which are separated, of a secondary battery according to some embodiments of the present disclosure, showing section A-A of FIG. 1.

FIG. 12 is a cross-sectional view of the binding surfaces of the case body and the case cover of the secondary battery of FIG. 11 according to some embodiments of the present disclosure.

FIG. 13 is a cross-sectional view of inclined binding surfaces of a case body and a case cover of a secondary battery according to some embodiments of the present disclosure.

FIG. 14 is a cross-sectional view of binding surfaces of a case body and a case cover, which are separated, of a secondary battery according to some embodiments of the present disclosure, showing section A-A of FIG. 1.

FIG. 15 is a cross-sectional view of the binding surfaces of the case body and the case cover of the secondary battery of FIG. 14 according to some embodiments of the present disclosure.

FIG. 16 is a cross-sectional view of inclined binding surfaces of a case body and a case cover of a secondary battery according to some embodiments of the present disclosure.

FIG. 17 is a cross-sectional view of binding surfaces of a case body and a case cover, which are separated, of a secondary battery according to some embodiments of the present disclosure, showing section A-A of FIG. 1.

FIG. 18 is a cross-sectional view of the binding surfaces of the case body and the case cover of the secondary battery of FIG. 17 according to some embodiments of the present disclosure.

FIG. 19 is a cross-sectional view of inclined binding surfaces of a case body and a case cover of a secondary battery according to some embodiments of the present disclosure.

FIG. 20 is a cross-sectional view of binding surfaces of a case body and a case cover, which are separated, of a secondary battery according to some embodiments of the present disclosure, showing section A-A of FIG. 1.

FIG. 21 is a cross-sectional view of the binding surfaces of the case body and the case cover of the secondary battery of FIG. 20 according to some embodiments of the present disclosure.

FIG. 22 is a cross-sectional view of inclined binding surfaces of a case body and a case cover of a secondary battery according to some embodiments of the present disclosure.

FIG. 23 is a cross-sectional view of binding surfaces of a case body and a case cover, which are separated, of a secondary battery according to some embodiments of the present disclosure, showing section A-A of FIG. 1.

FIG. 24 is a cross-sectional view of the binding surfaces of the case body and the case cover of the secondary battery of FIG. 23 according to some embodiments of the present disclosure.

FIG. 25 is a cross-sectional view of inclined binding surfaces of a case body and a case cover of a secondary battery according to some embodiments of the present disclosure.

FIG. 26 is a cross-sectional view of a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

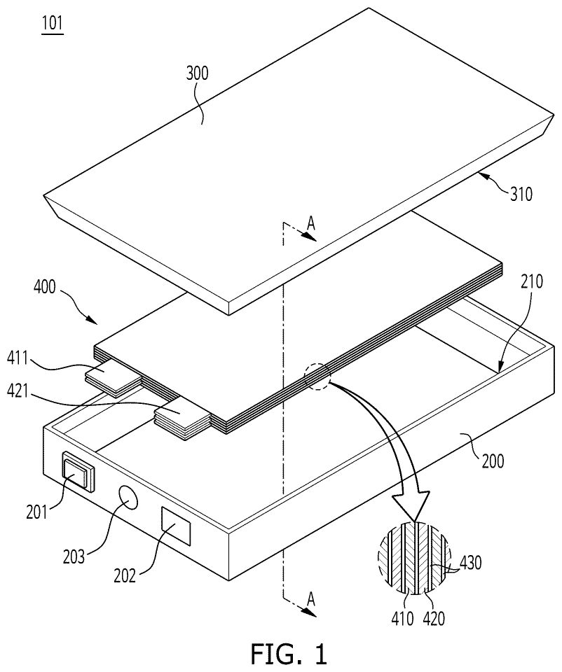

FIG. 1 is a perspective view of a secondary battery according some embodiments of the present disclosure.

Referring to FIG. 1, a secondary battery 101 according to some embodiments of the present disclosure may include an electrode assembly 400 including a first electrode 410, a second electrode 420, and a separator 430, a case body 200 accommodating the electrode assembly 400 in one opened side surface and including a first binding surface 210 formed along a circumference of the one opened side surface, and a case cover 300 bound to the one opened side surface of the case body 200 and including a second binding surface formed along a circumference of the case cover such that the second binding surface is bound to the first binding surface 210.

The electrode assembly 400 may be formed by winding or stacking a stack of a first electrode 410, a separator 430, and a second electrode 420, which are formed as thin plates or films. When the electrode assembly 400 is a wound stack, a winding axis may be parallel to the longitudinal direction of the case. In other embodiments, the electrode assembly 400 may be a stack type rather than a winding type, and the shape of the electrode assembly 400 is not limited in the present disclosure. In addition, the electrode assembly 400 may be a Z-stack electrode assembly 400 in which a positive electrode plate and a negative electrode plate are inserted into both sides of a separator 430, which is then bent into a Z-stack. In addition, one or more electrode assemblies may be stacked such that long sides of the electrode assemblies are adjacent to each other and accommodated in the case body 200, and the number of electrode assemblies in the case is not limited in the present disclosure. The first electrode 410 of the electrode assembly 400 may act as a negative electrode, and the second electrode 420 may act as a positive electrode. Of course, the reverse is also possible.

The first electrode 410 may be formed by applying a first electrode active material, such as graphite or carbon, to a first electrode current collector formed of a metal foil, such as copper, a copper alloy, nickel, or a nickel alloy. The first electrode 410 may include a first electrode tab 411 that is a region to which the first electrode active material is not applied. The first electrode tab 411 may act as a current flow path between the first electrode 410 and the first current collector. In some embodiments, when the first electrode 410 is manufactured, the first electrode tab 411 may be formed by being cut in advance to protrude to one side of the electrode assembly 400, or the first electrode tab 411 may protrude to one side of the electrode assembly 400 more than (e.g., farther than or beyond) the separator 430 without being separately cut.

The second electrode 420 may be formed by applying a second electrode active material, such as a transition metal oxide, on a second electrode current collector formed of a metal foil, such as aluminum or an aluminum alloy. The second electrode 420 may include a second electrode tab 421 that is a region to which the second electrode active material is not applied. The second electrode tab 421 may act as a current flow path between the second electrode 420 and the second current collector. In some embodiments, the second electrode tab 421 may be formed by being cut in advance to protrude to the other side (e.g., the opposite side) of the electrode assembly 400 when the second electrode 420 is manufactured, or the second electrode 420 may protrude to the other side of the electrode assembly 400 more than (e.g., farther than or beyond) the separator 430 without being separately cut.

The case body 200 may form an overall appearance of the secondary battery 101. The case body 200 may be formed of stainless steel (stainless use steel, SUS). However, the case body 200 is not limited thereto, and the case body 200 may be formed of a conductive metal such as aluminum and/or steel coated with an aluminum alloy or nickel.

The case body 200 has one opened side surface to house the electrode assembly 400. The one opened side surface of the case body 200 may be bound with the case cover 300 to be sealed.

A first electrode terminal 201 and a second electrode terminal 202 may be disposed in the case body 200 by being spaced from each other. The first electrode terminal 201 may be bound and electrically connected with a first electrode tab 411 of the first electrode 410 of the electrode assembly 400. The second electrode terminal 202 may be bound and electrically connected with a second electrode tab 421 of the second electrode 420 of the electrode assembly 400.

One of the first electrode terminal 201 and the second electrode terminal 202 may be electrically insulated from the case body 200. In some embodiments, in a case where the case body 200 functions as a cathode and the first electrode terminal 201 functions as an anode, an insulator (not illustrated) may be further provided between the first electrode terminal 201 and the case body 200. With such a configuration, the first electrode terminal 201 may function as an anode in a state of being insulated from the case body 200 and the second electrode terminal 202 may function as a cathode in a state of being in contact with the case body 200. The second electrode terminal 202 may be also electrically insulated from the case body 200.

A liquid injection hole 203 may be formed to inject an electrolyte in the case body 200. The liquid injection hole 203 may be formed between the first electrode terminal 201 and the second electrode terminal 202. A position at which the liquid injection hole 203 is formed is not limited thereto.

The case body 200 may have a first binding surface 210 formed along a circumference of the one opened side surface, and the case cover 300 bound to the one opened side surface of the case body 200 may have a second binding surface formed along a circumference of the case cover such that the second binding surface is bound to the first binding surface 210. In some embodiments, the case body 200 and the case cover 300 may be bound to each other by welding, where the first binding surface 210 of the case body 200 and the second binding surface of the case cover 300 are stacked together. When at least a part of the first binding surface 210 and the second binding surface are inclined, the first binding surface 210 and the second binding surface may be in contact together sufficiently so that favorable welding characteristics may be achieved during welding.

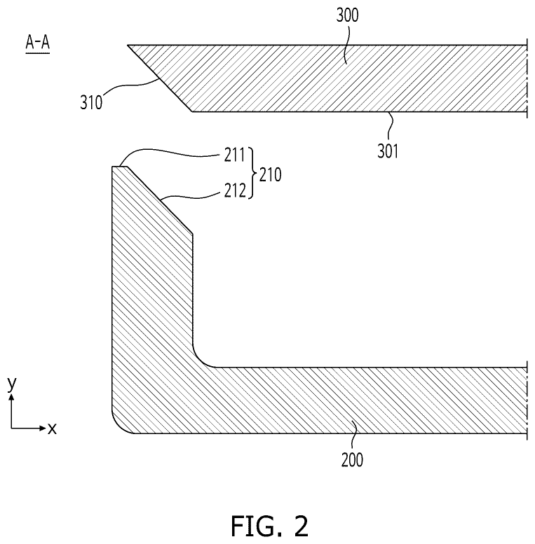

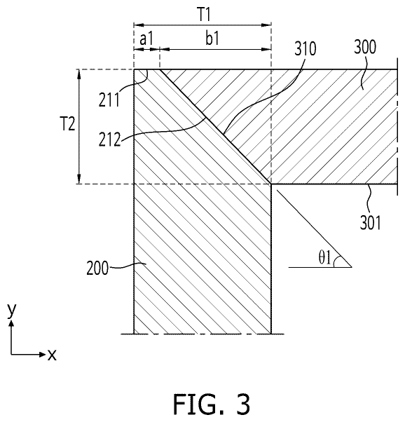

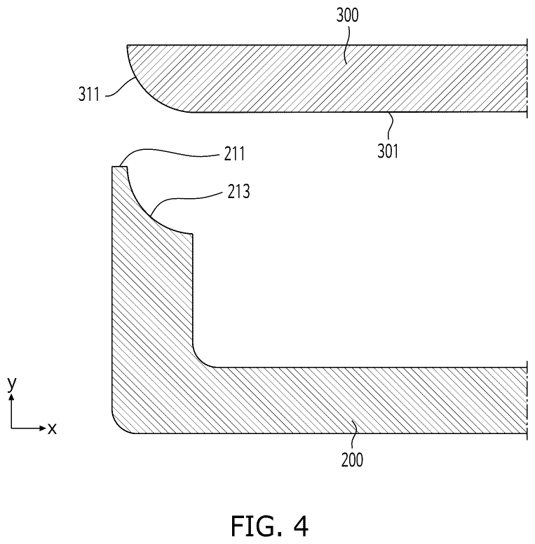

FIG. 2 is a cross-sectional view of binding surfaces of a case body and a case cover, which are separated, of the secondary battery according to some embodiments of the present disclosure, showing section A-A of FIG. 1. FIG. 3 is a cross-sectional view of the binding surfaces of the case body and the case cover of the secondary battery of FIG. 2 according to some embodiments of the present disclosure. FIG. 4 is a cross-sectional view of inclined binding surfaces of a case body and a case cover of a secondary battery according to some embodiments of the present disclosure.

Referring to FIGS. 2 to 4, in some embodiments, the first binding surface 210 of the case body 200 may include a first horizontal surface 211 parallel to a first direction X and a first inclined surface 212 extending toward a bottom surface of the case body 200 from the first horizontal surface 211. The second binding surface of the case cover 300 may include a second inclined surface 310 tightly in contact with the first inclined surface 212. In some embodiments, the second binding surface may have the same configuration as that of the second inclined surface 310.

In some embodiments, a length a1 of the first horizontal surface 211 of the first binding surface 210 may be 1% to 10% of a thickness T1 of the case body 200. The thickness T1 of the case body 200 may correspond to a length of the first binding surface 210 in the first direction X. The first direction X may be a direction parallel to the case cover 300, and a second direction Y may be a vertical direction orthogonal to the first direction X. A thickness T2 of the case cover 300 may correspond to a length of a second binding surface 370 in the second direction Y.

The first horizontal surface 211 may have the same height as that of an outer circumferential surface of the case cover 300, and the first inclined surface 212 and the second inclined surface 310 may be tightly in contact together. The first horizontal surface 211 and the outer circumferential surface of the case cover 300 may make the same plane.

The first inclined surface 212 of the first binding surface 210 may be inclined at a predetermined angle θ1 with respect to the bottom surface of the case body 200 in the first direction X. The second inclined surface 310, which is a second binding surface, may have a same angle and a same size as those of the first inclined surface 212.

In some embodiments, the angle θ1 of the first inclined surface 212 and the second inclined surface 310 may be more than 0 degrees and less than or equal to 60 degrees with respect to the first direction X. A size b1 of the first inclined surface 212 and the second inclined surface 310 in the first direction X may be the same as each other. The angle θ1 of the first inclined surface 212 and the second inclined surface 310 may be set in accordance with the thickness T2 of the case cover 300, the thickness T1 of the case body 200, and the length a1 of the first horizontal surface 211.

Referring to FIG. 4, a second inclined surface 311 may be convexly formed. Further, a first inclined surface 213 may be formed in a shape corresponding to the second inclined surface 311 to be tightly in contact with the second inclined surface 311. The first inclined surface 213 may be concavely formed to be tightly in contact with the convexly formed second inclined surface 311. In some embodiments, the second inclined surface may be concavely formed, and the first inclined surface may be convexly formed, corresponding thereto.

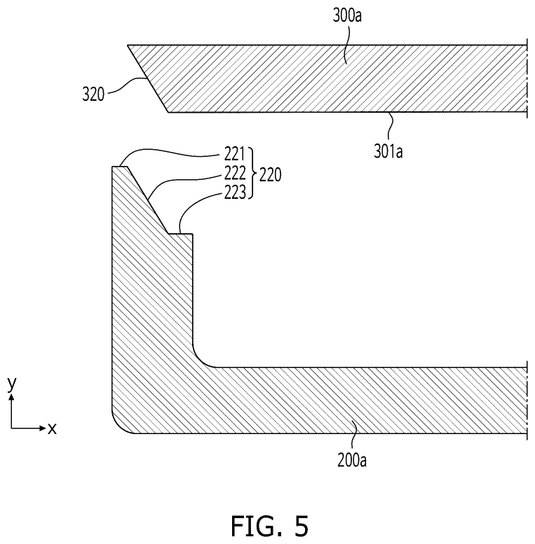

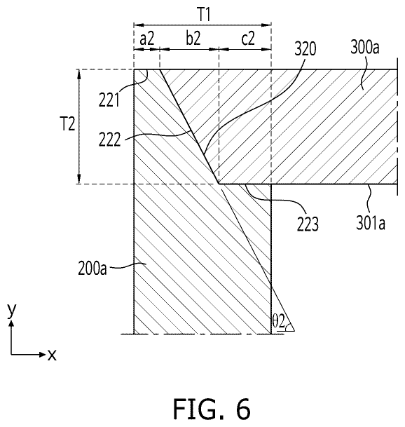

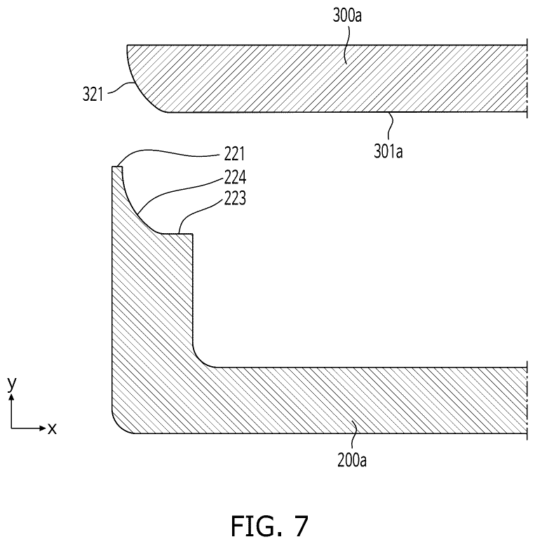

FIG. 5 is a cross-sectional view of binding surfaces of a case body and a case cover, which are separated, of a secondary battery according to some embodiments of the present disclosure, showing section A-A of FIG. 1. FIG. 6 is a cross-sectional view of the binding surfaces of the case body and the case cover of the secondary battery of FIG. 5 according to some embodiments of the present disclosure. FIG. 7 is a cross-sectional view of inclined binding surfaces of a case body and a case cover of a secondary battery according to some embodiments of the present disclosure.

Referring to FIGS. 5 to 7, in some embodiments, the first binding surface 220 of the case body 200a may include a first outer horizontal surface 221 parallel to the first direction X, a first inclined surface 222 extending toward the bottom surface of the case body 200a, and a first inner horizontal surface 223 which extends parallel to the first direction X from the first inclined surface 222 and on which an inner circumferential surface 301a of the case cover 300a settles. The second binding surface of the case cover 300a may include the second inclined surface 320 tightly in contact with the first inclined surface 222. In some embodiments, the second binding surface may have the same configuration as that of the second inclined surface 320.

In some embodiments, a length a2 of the first outer horizontal surface 221 of the first binding surface 220 may be 1% to 10% of the thickness T1 of the case body 200 a. A length c2 of the first inner horizontal surface 223 of the first binding surface 220 may be 10% to 20% of the thickness T1 of the case body 200a.

The first outer horizontal surface 221 may have the same height as that of an outer circumferential surface of the case cover 300a, and the first inclined surface 222 and the second inclined surface 320 may be tightly in contact together. The first outer horizontal surface 221 and the outer circumferential surface of the case cover 300a may make the same plane.

The first inclined surface 222 of the first binding surface 220 may be inclined at a predetermined angle θ2 with respect to the bottom surface of the case body 200a in the first direction X. The second inclined surface 320, which is a second binding surface, may have a same angle θ2 and a same size as those of the first inclined surface 222.

In some embodiments, the angle θ2 of the first inclined surface 222 and the second inclined surface 320 may be more than 0 degrees and less than or equal to 60 degrees with respect to the first direction X. A size b2 of the first inclined surface 222 and the second inclined surface 320 in the first direction X may be the same as each other. The angle θ1 of the first inclined surface 222 and the second inclined surface 320 may be set in accordance with the thickness T2 of the case cover 300a, the thickness T1 of the case body 200a, the length a2 of the first outer horizontal surface 221, and the length c2 of the first inner horizontal surface 223.

Referring to FIG. 7, a second inclined surface 321 may be convexly formed. Further, a first inclined surface 224 may be formed in a shape corresponding to the second inclined surface 321 to be tightly in contact with the second inclined surface 321. The first inclined surface 224 may be concavely formed to be tightly in contact with the convexly formed second inclined surface 321. In some embodiments, the second inclined surface may be concavely formed, and the first inclined surface may be convexly formed, corresponding thereto.

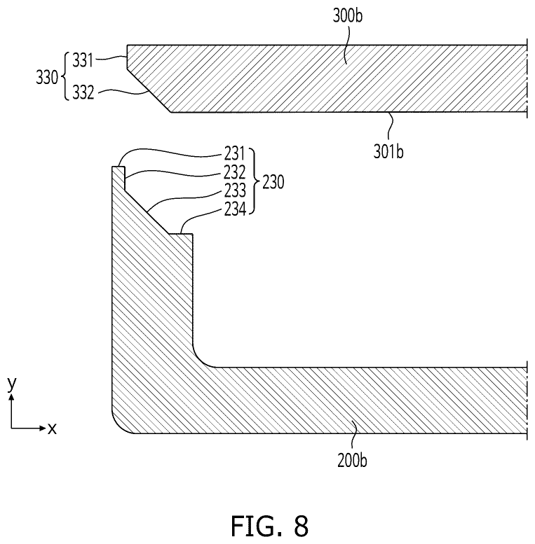

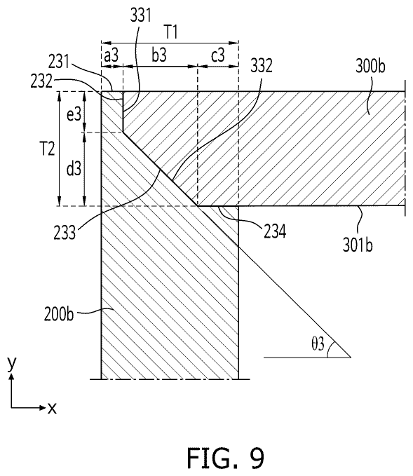

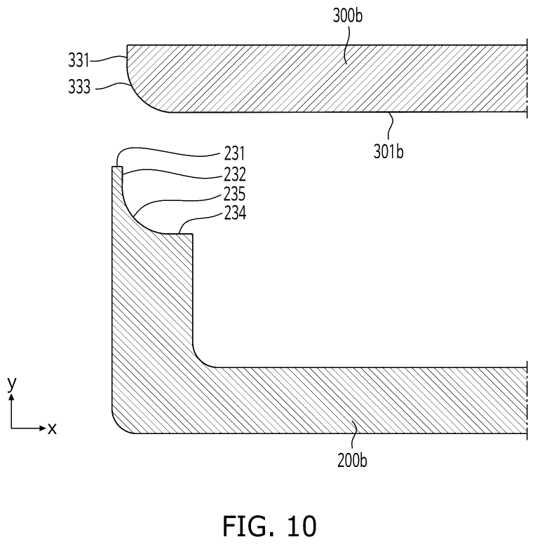

FIG. 8 is a cross-sectional view of binding surfaces of a case body and a case cover, which are separated, of a secondary battery according to some embodiments of the present disclosure, showing section A-A of FIG. 1. FIG. 9 is a cross-sectional view of the binding surfaces of the case body and the case cover of the secondary battery of FIG. 8 according to some embodiments of the present disclosure. FIG. 10 is a cross-sectional view of inclined binding surfaces of a case body and a case cover of a secondary battery according to some embodiments of the present disclosure.

Referring to FIGS. 8 to 10, in some embodiments, a first binding surface 230 of the case body 200b may include a first outer horizontal surface 231 parallel to the first direction X, a first vertical surface 232 extending in a direction orthogonal to the first outer horizontal surface 231, a first inclined surface 233 extending toward the bottom surface of the case body 200b from the first vertical surface 232, and a first inner horizontal surface 234 which extends parallel to the first direction X from the first inclined surface 233 and on which the inner circumferential surface 301b of the case cover 300b settles. A second binding surface 330 of the case cover 300b may include a second vertical surface 331 tightly in contact with the first vertical surface 232 and a second inclined surface 332 extending from the second vertical surface 331 and tightly in contact with the first inclined surface 233.

In some embodiments, a length a3 of the first outer horizontal surface 231 of the first binding surface 230 may be 1% to 10% of the thickness T1 of the case body 200 b. A length e3 of the first vertical surface 232 of the first binding surface 230 may be 1% to 20% of the thickness T2 of the case cover 300b. A length c3 of the first inner horizontal surface 234 of the first binding surface 230 may be 10% to 20% of the thickness T1 of the case body 200 b.

The first outer horizontal surface 231 may have the same height as that of an outer circumferential surface of the case cover 300b, and the first inclined surface 233 and the second inclined surface 332 may be tightly in contact together. The first outer horizontal surface 231 and the outer circumferential surface of the case cover 300b may make the same plane.

The first inclined surface 233 of the first binding surface 230 may be inclined at a predetermined angle θ3 with respect to the bottom surface of the case body 200b in the first direction X. The second inclined surface 332 of the second binding surface 330 may have a same angle and a same size as those of the first inclined surface 233.

In some embodiments, the angle θ3 of the first inclined surface 233 and the second inclined surface 332 may be more than 0 degrees and less than or equal to 60 degrees with respect to the first direction X. A size b2 of the first inclined surface 233 and the second inclined surface 332 in the first direction X may be the same as a size d3 thereof in the second direction Y. The angle θ3 of the first inclined surface 233 and the second inclined surface 332 may be set in accordance with the thickness T2 of the case cover 300b, the thickness T1 of the case body 200b, the length a3 of the first outer horizontal surface 231, and the length c3 of the first inner horizontal surface 234.

Referring to FIG. 10, a second inclined surface 333 may be convexly formed. Further, a first inclined surface 235 may be formed in a shape corresponding to the second inclined surface 333 to be tightly in contact with the second inclined surface 333. The first inclined surface 235 may be concavely formed to be tightly in contact with the convexly formed second inclined surface 333. In some embodiments, the second inclined surface may be concavely formed, and the first inclined surface may be convexly formed, corresponding thereto.

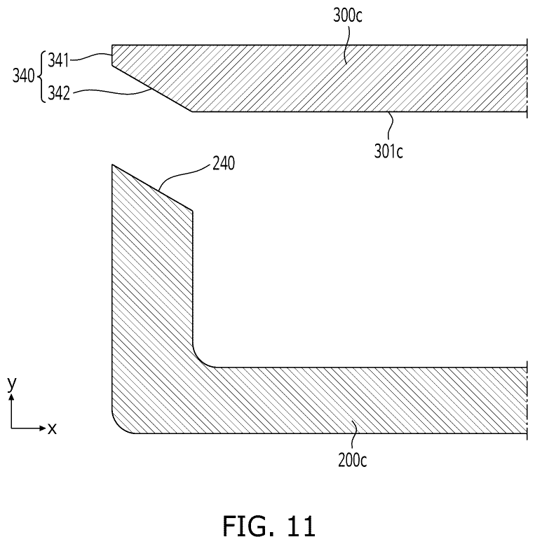

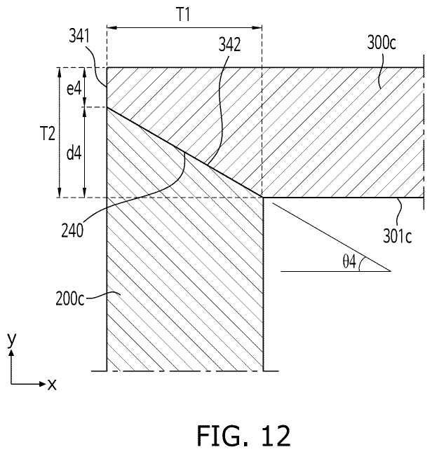

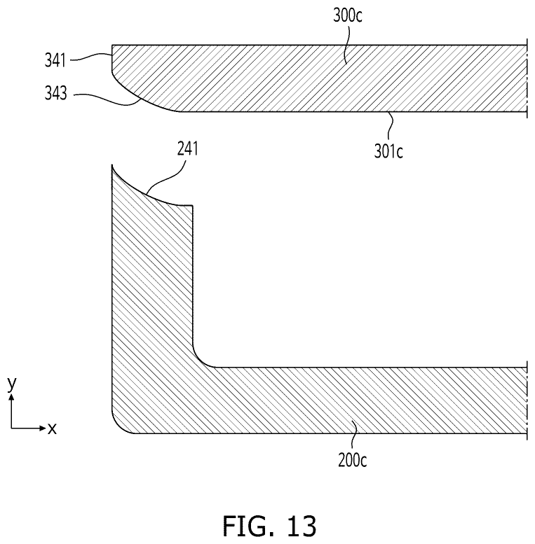

FIG. 11 is a cross-sectional view of binding surfaces of a case body and a case cover, which are separated, of a secondary battery according to some embodiments of the present disclosure, showing section A-A of FIG. 1. FIG. 12 is a cross-sectional view of the binding surfaces of the case body and the case cover of the secondary battery of FIG. 11 according to some embodiments of the present disclosure. FIG. 13 is a cross-sectional view of inclined binding surfaces of a case body and a case cover of a secondary battery according to some embodiments of the present disclosure.

Referring to FIGS. 11 to 13, in some embodiments, a second binding surface 340 of the case cover 300c may include a second vertical surface 341 orthogonal to the first direction X and a second inclined surface 342 extending toward the bottom surface of the case body 200c from the second vertical surface 341. The first binding surface of the case body 200c may include the first inclined surface 240 tightly in contact with the second inclined surface 342. In some embodiments, the first binding surface may have the same configuration as that of the first inclined surface 240.

In some embodiments, a length e4 of the second vertical surface 341 of the second binding surface 340 may be 1% to 20% of the thickness of the case cover 300 c. The second vertical surface 341 may have the same height as that of an outer circumferential surface of the case body 200c, and the first inclined surface 240 and the second inclined surface 342 may be tightly in contact together. The second vertical surface 341 and the outer circumferential surface of the case body 200c may make the same plane.

The first inclined surface 240 which is a first binding surface may be inclined at a predetermined angle θ4 with respect to the bottom surface of the case body 200c in the first direction X. The second inclined surface 342 of the second binding surface 340 may have a same angle θ4 and a same size as those of the first inclined surface 240.

In some embodiments, the angle θ4 of the first inclined surface 240 and the second inclined surface 342 may be more than 0 degrees and less than or equal to 60 degrees with respect to the first direction X. The size d4 of the first inclined surface 240 and the second inclined surface 342 in the second direction Y may be the same as each other. The angle θ4 of the first inclined surface 240 and the second inclined surface 342 may be set in accordance with the thickness T2 of the case cover 300c, the thickness T1 of the case body 200c, and the length e4 of the second vertical surface 341.

Referring to FIG. 13, a second inclined surface 343 may be convexly formed. Further, a first inclined surface 241 may be formed in a shape corresponding to the second inclined surface 343 to be tightly in contact with the second inclined surface 343. The first inclined surface 241 may be concavely formed to be tightly in contact with the convexly formed second inclined surface 343. In some embodiments, the second inclined surface may be concavely formed, and the first inclined surface may be convexly formed, corresponding thereto.

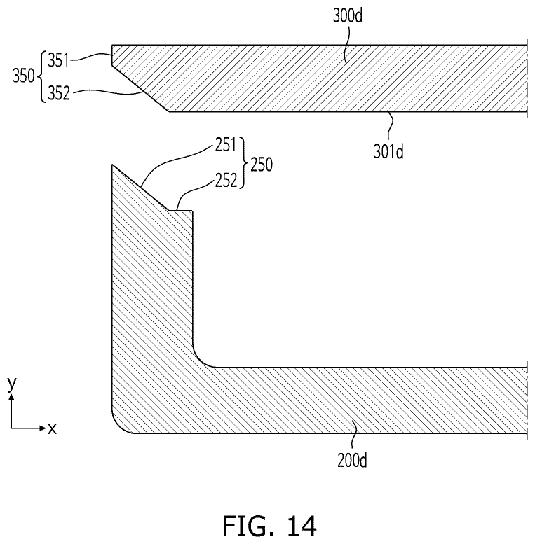

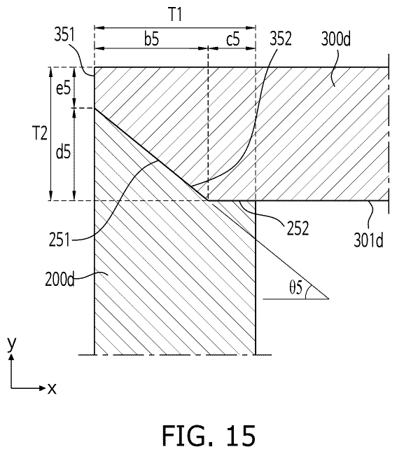

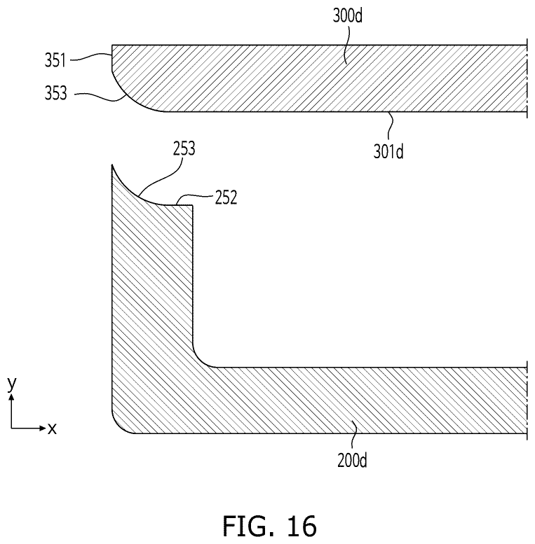

FIG. 14 is a cross-sectional view of binding surfaces of a case body and a case cover, which are separated, of a secondary battery according to some embodiments of the present disclosure, showing section A-A of FIG. 1. FIG. 15 is a cross-sectional view of the binding surfaces of the case body and the case cover of the secondary battery of FIG. 14 according to some embodiments of the present disclosure. FIG. 16 is a cross-sectional view of inclined binding surfaces of a case body and a case cover of a secondary battery according to some embodiments of the present disclosure.

Referring to FIGS. 14 to 16, in some embodiments, a second binding surface 350 of the case cover 300d may include a second vertical surface 351 orthogonal to the first direction X and a second inclined surface 352 extending toward the bottom surface of the case body 200d from the second vertical surface 351. A first binding surface 250 of the case body 200d may include a first inclined surface 251 tightly in contact with the second inclined surface 352 and a first horizontal surface 252 which extends parallel to the first direction X from the first inclined surface 251 and on which the inner circumferential surface 301d of the case cover 300d settles.

A length e5 of the second vertical surface 351 of the second binding surface 350 may be 1% to 20% of the thickness T2 of the case cover 300 d. The length c5 of the first horizontal surface 252 of the first binding surface 250 may be 10% to 20% of the thickness T1 of the case body 200d.

The second vertical surface 351 may have the same height as that of the outer circumferential surface of the case body 200d, and the first inclined surface 251 and the second inclined surface 352 may be tightly in contact together. The second vertical surface 351 and the outer circumferential surface of the case body 200d may make the same plane.

The first inclined surface 251 of the first binding surface 250 may be inclined at a predetermined angle θ5 with respect to the bottom surface of the case body 200d in the first direction X. The second inclined surface 352 of the second binding surface 350 may have a same angle θ5 and a same size as those of the first inclined surface 251.

In some embodiments, the angle θ5 of the first inclined surface 251 and the second inclined surface 352 may be more than 0 degrees and less than or equal to 60 degrees with respect to the first direction X. A size b5 of the first inclined surface 251 and the second inclined surface 352 in the first direction X may be the same as a size d5 thereof in the second direction Y. The angle θ5 of the first inclined surface 251 and the second inclined surface 352 may be set in accordance with the thickness T2 of the case cover 300d, the thickness T1 of the case body 200d, the length e5 of the second vertical surface 351, and the length c5 of the first horizontal surface 252.

Referring to FIG. 16, a second inclined surface 353 may be convexly formed. Further, a first inclined surface 253 may be formed in a shape corresponding to the second inclined surface 353 to be tightly in contact with the second inclined surface 353. The first inclined surface 253 may be concavely formed to be tightly in contact with the convexly formed second inclined surface 353. In some embodiments, the second inclined surface may be concavely formed, and the first inclined surface may be convexly formed, corresponding thereto.

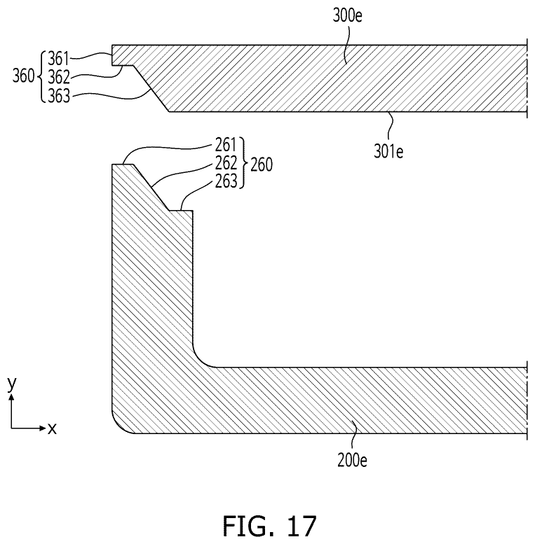

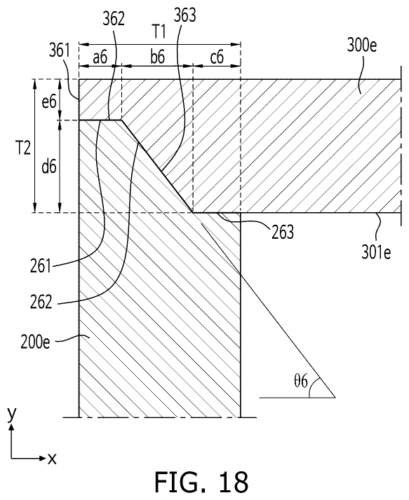

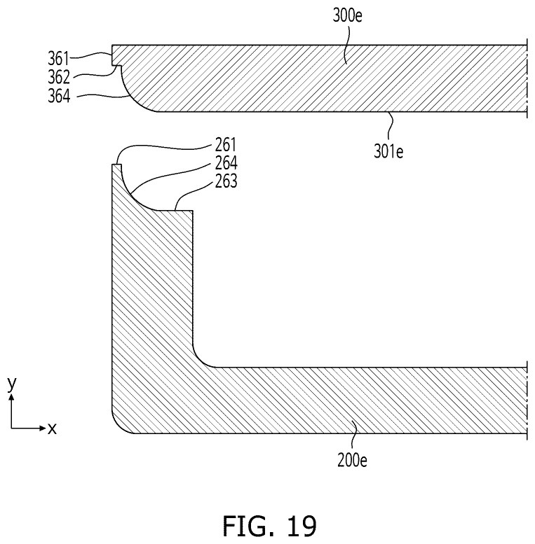

FIG. 17 is a cross-sectional view of binding surfaces of a case body and a case cover, which are separated, of a secondary battery according to some embodiments of the present disclosure, showing section A-A of FIG. 1. FIG. 18 is a cross-sectional view of the binding surfaces of the case body and the case cover of the secondary battery of FIG. 17 according to some embodiments of the present disclosure. FIG. 19 is a cross-sectional view of inclined binding surfaces of a case body and a case cover of a secondary battery according to some embodiments of the present disclosure.

Referring to FIGS. 17 to 19, in some embodiments, a second binding surface 360 of the case cover 300e may include a second vertical surface 361 orthogonal to the first direction X, a second horizontal surface 362 which extends parallel to the first direction X from the second vertical surface 361, and a second inclined surface 363 extending toward the bottom surface of the case body 200e from the second horizontal surface 362. A first binding surface 260 of the case body 200e may include a first outer horizontal surface 261 parallel to the first direction X and tightly in contact with the second horizontal surface 362, a first inclined surface 262 extending toward the bottom surface of the case body 200e from the first outer horizontal surface 261 and tightly in contact with a second inclined surface 363, and a first inner horizontal surface 263 which extends parallel to the first direction X from the first inclined surface 262 and on which an inner circumferential surface 301e of the case cover 300e settles.

In some embodiments, a length e6 of the second vertical surface 361 of the second binding surface 360 may be 1% to 20% of the thickness of the case cover 300e. A length a6 of the first outer horizontal surface 261 of the first binding surface 260 may be 1% to 10% of the thickness of the case body 200e. A length c6 of the first inner horizontal surface 263 of the first binding surface 260 may be 10% to 20% of the thickness of the case body 200 e.

The second vertical surface 361 may have the same height as that of the outer circumferential surface of the case body 200e, and the first inclined surface 262 and the second inclined surface 363 may be tightly in contact together. The second vertical surface 361 and the outer circumferential surface of the case body 200e may make the same plane.

The first inclined surface 262 of the first binding surface 260 may be inclined at a predetermined angle θ6 with respect to the bottom surface of the case body 200e in the first direction X. The second inclined surface 363 of the second binding surface 360 may have a same angle θ6 and a same size as those of the first inclined surface 262.

In some embodiments, the angle θ6 of the first inclined surface 262 and the second inclined surface 363 may be more than 0 degrees and less than or equal to 60 degrees with respect to the first direction X. A size b6 of the first inclined surface 262 and the second inclined surface 363 in the first direction X may be the same as a size d6 thereof in the second direction Y. The angle θ6 of the first inclined surface 262 and the second inclined surface 363 may be set in accordance with the thickness T2 of the case cover 300e, the thickness T1 of the case body 200e, the length e6 of the second vertical surface 361, the length a6 of the first outer horizontal surface 261, and the length c6 of the first inner horizontal surface 263.

Referring to FIG. 19, the second inclined surface 364 may be convexly formed. Further, a first inclined surface 264 may be formed in a shape corresponding to the second inclined surface 364 to be tightly in contact with the second inclined surface 364. The first inclined surface 264 may be concavely formed to be tightly in contact with the convexly formed second inclined surface 364. In some embodiments, the second inclined surface may be concavely formed, and the first inclined surface may be convexly formed, corresponding thereto.

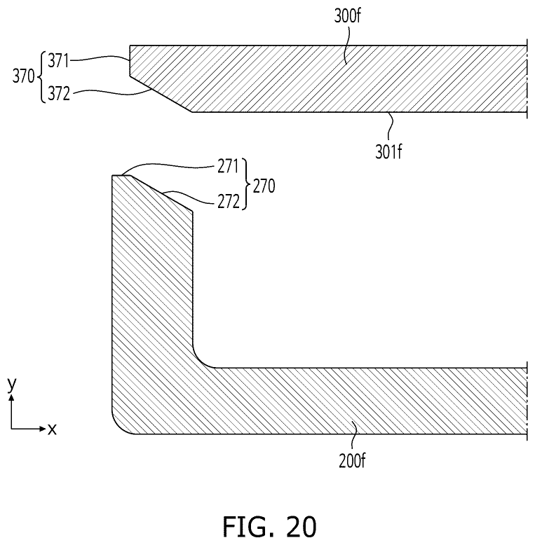

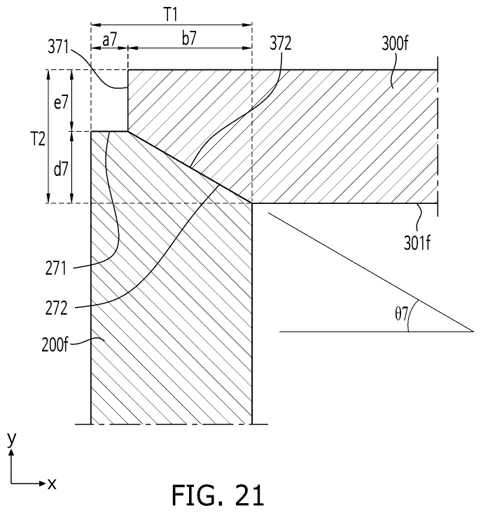

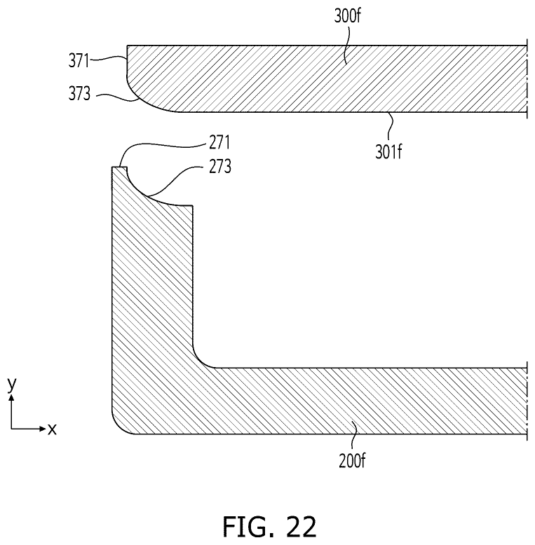

FIG. 20 is a cross-sectional view of binding surfaces of a case body and a case cover, which are separated, of a secondary battery according to some embodiments of the present disclosure, showing section A-A of FIG. 1. FIG. 21 is a cross-sectional view of the binding surfaces of the case body and the case cover of the secondary battery of FIG. 20 according to some embodiments of the present disclosure. FIG. 22 is a cross-sectional view of inclined binding surfaces of a case body and a case cover of a secondary battery according to some embodiments of the present disclosure.

Referring to FIGS. 20 to 22, in some embodiments, a second binding surface 370 of the case cover 300f may include a second vertical surface 371 orthogonal to the first direction X and a second inclined surface 372 extending toward the bottom surface of the case body 200f from the second vertical surface 371. A first binding surface 270 of the case body 200f may include a first horizontal surface 271 parallel to the first direction X and a first inclined surface 272 extending toward the bottom surface of the case body 200f and tightly in contact with the second inclined surface 372.

In some embodiments, a length e7 of the second vertical surface 371 of the second binding surface 370 may be 1% to 20% of the thickness of the case cover 300 f. A length a7 of the first horizontal surface 271 of the first binding surface 270 may be 1% to 10% of the thickness of the case body 200f.

The second vertical surface 371 may be disposed inwardly by the length a7 of the first horizontal surface 271 from the outer circumferential surface of the case body 200f. The first horizontal surface 271 may be disposed inwardly by the length e7 of the second vertical surface 371 from the outer circumferential surface of the case cover 300f, and the first inclined surface 272 and the second inclined surface 372 may be tightly in contact together. The second vertical surface 371 and the first horizontal surface 271 may be exposed to the outside, and the first inclined surface 272 and the second inclined surface 372 may be tightly in contact together.

The first inclined surface 272 of the first binding surface 270 may be inclined at a predetermined angle θ7 with respect to the bottom surface of the case body 200f based in the first direction X. The second inclined surface 372 of the second binding surface 370 may have a same angle θ7 and a same size as those of the first inclined surface 272.

In some embodiments, the angle θ7 of the first inclined surface 272 and the second inclined surface 372 may be more than 0 degrees and less than or equal to 60 degrees with respect to the first direction X. A size b7 of the first inclined surface 272 and the second inclined surface 372 in the first direction X may be the same as a size d7 thereof in the second direction Y. The angle θ7 of the first inclined surface 272 and the second inclined surface 372 may be set in accordance with the thickness T2 of the case cover 300f, the thickness T1 of the case body 200f, the length e7 of the second vertical surface 371, and the length a7 of the first horizontal surface 271.

Referring to FIG. 22, a second inclined surface 373 may be convexly formed. Further, a first inclined surface 273 may be formed in a shape corresponding to the second inclined surface 373 to be tightly in contact with the second inclined surface 373. The first inclined surface 273 may be concavely formed to be tightly in contact with the convexly formed second inclined surface 373. In some embodiments, the second inclined surface may be concavely formed, and the first inclined surface may be convexly formed, corresponding thereto.

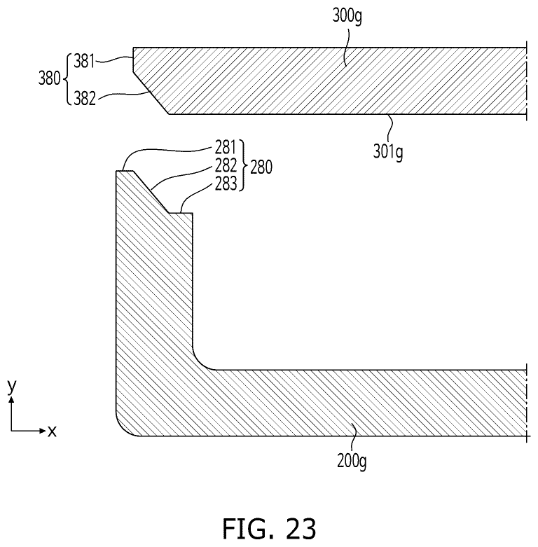

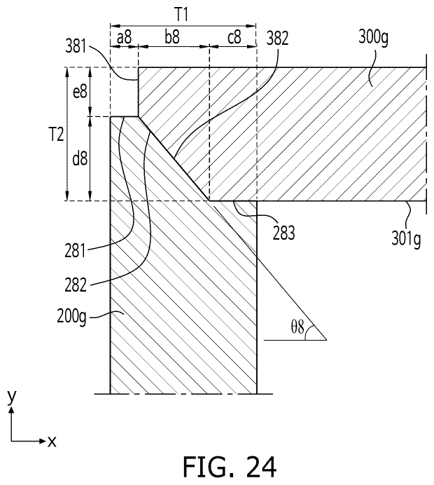

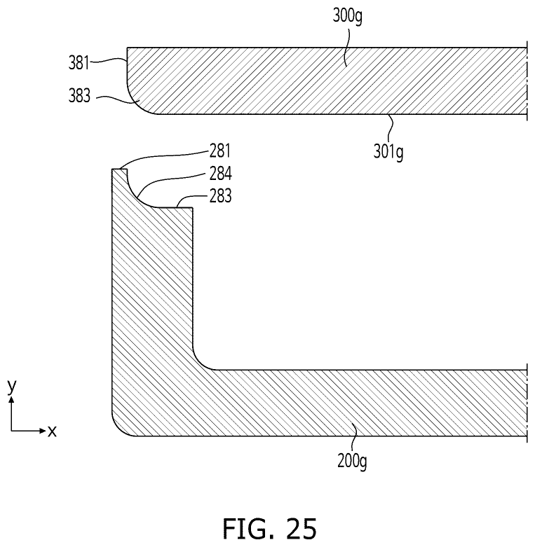

FIG. 23 is a cross-sectional view of binding surfaces of a case body and a case cover, which are separated, of a secondary battery according to some embodiments of the present disclosure, showing section A-A of FIG. 1. FIG. 24 is a cross-sectional view of the binding surfaces of the case body and the case cover of the secondary battery of FIG. 23 according to some embodiments of the present disclosure. FIG. 25 is a cross-sectional view of inclined binding surfaces of a case body and a case cover of a secondary battery according to some embodiments of the present disclosure.

Referring to FIGS. 23 to 25, in some embodiments, a second binding surface 380 of the case cover 300g may include a second vertical surface 381 orthogonal to the first direction X and a second inclined surface 382 extending toward the bottom surface of the case body 200g from the second vertical surface 381. A first binding surface 280 of the case body 200g may include a first outer horizontal surface 281 parallel to the first direction X, a first inclined surface 282 extending toward the bottom surface of the case body 200g from the first outer horizontal surface 281 and tightly in contact with the second inclined surface 382, and a first inner horizontal surface 283 which extends parallel to the first direction X from the first inclined surface 282 and on which the inner circumferential surface 301g of the case cover 300g settles.

In some embodiments, a length a8 of the second vertical surface 381 of the second binding surface 380 may be 1% to 20% of the thickness of the case cover 300g. The length a8 of the first outer horizontal surface 281 of the first binding surface 280 may be 1% to 10% of the thickness T1 of the case body 200g. A length c8 of the first inner horizontal surface 283 of the first binding surface 280 may be 10% to 20% of the thickness T1 of the case body 200g.

The second vertical surface 381 may be disposed inwardly by the length a8 of the first outer horizontal surface 281 from the outer circumferential surface of the case body 200g, and the first inclined surface 282 and the second inclined surface 382 may be tightly in contact together. The first outer horizontal surface 281 may be disposed inwardly by a length e8 of the second vertical surface 381 from the outer circumferential surface of the case cover 300g, and the first inclined surface 282 and the second inclined surface 382 may be tightly in contact together. The second vertical surface 381 and the first outer horizontal surface 281 may be exposed to the outside, and the first inclined surface 282 and the second inclined surface 382 may be tightly in contact together.

The first inclined surface 282 of the first binding surface 280 may be inclined at a predetermined angle θ8 with respect to the bottom surface of the case body 200g in the first direction X. The second inclined surface 382 of the second binding surface 380 may have a same angle and a same size as those of the first inclined surface 282.

In some embodiments, the angle θ8 of the first inclined surface 282 and the second inclined surface 382 may be more than 0 degrees and less than or equal to 60 degrees with respect to the first direction X. A size b8 of the first inclined surface 282 and the second inclined surface 382 in the first direction X may be the same as a size d8 thereof in the second direction Y. The angle θ8 of the first inclined surface 282 and the second inclined surface 382 may be set in accordance with the thickness T2 of the case cover 300g, the thickness T1 of the case body 200g, the length e8 of the second vertical surface 381, the length a8 of the first outer horizontal surface 281, and the length c8 of the first inner horizontal surface 283.

Referring to FIG. 25, a second inclined surface 383 may be convexly formed. Further, a first inclined surface 284 may be formed in a shape corresponding to the second inclined surface 383 to be tightly in contact with the second inclined surface 383. The first inclined surface 284 may be concavely formed to be tightly in contact with the convexly formed second inclined surface 383. In some embodiments, the second inclined surface may be concavely formed, and the first inclined surface may be convexly formed, corresponding thereto.

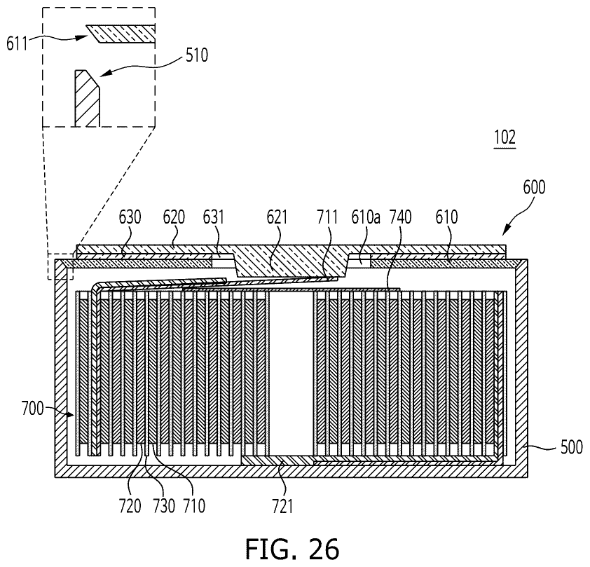

FIG. 26 is a cross-sectional view of a secondary battery according to some embodiments of the present disclosure.

Referring to FIG. 26, the secondary battery according to another embodiment of the present disclosure may be a cylindrical secondary battery. In some embodiments, a secondary battery 102 may include an electrode assembly 700 including a first electrode 710, a second electrode 720, and a separator 730, a case body 500 accommodating the electrode assembly 700 in one opened side surface and including a first binding surface 510 formed along a circumference of the one opened side surface, and a case cover 600 bound to the one opened side surface of the case body 500 and including a second binding surface 611 formed along a circumference of the case cover such that the second binding surface is bound to the first binding surface 510.

The electrode assembly 700 may include the separator 730 and the first electrode 710 and the second electrode 720 positioned with the separator 730 interposed therebetween and may be wound in a jelly-roll shape.

The first electrode 710 includes a first substrate and a first active material layer on the first substrate. A first lead tab 711 may extend outwardly from a first uncoated portion of the first substrate at where the first active material layer is not located, and the first lead tab 711 may be electrically connected to the case cover 600.

The second electrode 720 includes a second substrate and a second active material layer on the second substrate. A second lead tab 721 may extend outwardly from a second uncoated portion of the second substrate at where the second active material layer is not located, and the second lead tab 721 may be electrically connected to the case body 500. The first lead tab 711 and the second lead tab 721 may extend in opposite directions.

The first electrode 710 may act as a positive electrode. In such an embodiment, the first substrate may be made of, for example, an aluminum foil, and the first active material layer may include, for example, a transition metal oxide. The second electrode 720 may act as a negative electrode. In such an embodiment, the second substrate may be made of, for example, a copper foil or a nickel foil, and the second active material layer may include graphite, for example.

The separator 730 prevents a short circuit between the first electrode 710 and the second electrode 720 while allowing movement of lithium ions therebetween. The separator 730 may be made of, for example, a polyethylene film, a polypropylene film, a polyethylene-polypropylene film, or the like.

The case body 500 accommodates the electrode assembly 700 and, together with the case cover 600, forms the external appearance of the secondary battery. The case body 500 may have a substantially cylindrical body portion and a bottom portion connected to one side (e.g., to one end) of the body portion. The case may be made of a metal, such as aluminum, aluminum alloy, or nickel-plated steel. The second lead tab 721 may be attached to a bottom portion of the case body 500 to be electrically connected thereto.

The case cover 600 may include a cap plate 610 with an insertion hole 610a formed thereon; a terminal plate 620, which is disposed on the cap plate 610 and includes a bump portion 621 inserted into the insertion hole 610a; and an insulator 630 disposed between the cap plate 610 and the terminal plate 620.

The cap plate 610 may be formed in a disk shape having the insertion hole 610a formed in a center thereof. The cap plate 610 may have a diameter greater than those of the terminal plate 620 and the insulator 630. The cap plate 610 may have a second binding surface 611 formed along a circumference of the case cover, the second binding surface 611 bound to the first binding surface 510 formed on an upper side end of the case body 500 to close one opened side surface of the case body 500.

The terminal plate 620 may be formed in a disk shape having a diameter smaller than that of the cap plate 610 and may have a bump portion 621 formed in a center thereof such that the bump portion is inserted into the insertion hole 610a of the cap plate 610. The bump portion 621 may protrude inwardly to the case body 500 and may be inserted into the insertion hole 610a. Such a bump portion 621 may be configured to be attached with a first lead tab 711. The shape of the terminal plate 620 is not limited to the disk shape but may be formed into various shapes in accordance with the shape of the cap plate 610. As described above, the bump portion 621 is attached with the first lead tab 711, the case body 500 is attached with the second lead tab 721, and thus the terminal plate 620 may be configured to function as an anode and the case body 500 may be configured to function as a cathode.

The insulator 630 may be disposed between the cap plate 610 and the terminal plate 620 to electrically insulate the cap plate 610 and the terminal plate 620 from each other. The cap plate 610 and the terminal plate 620 are manufactured with conductive metal materials, and electrically connected to a cathode which is the second lead tab 721 and an anode which is the first lead tab 711, respectively, and thus the insulator 630 may prevent occurrence of a short circuit by insulating the cap plate 610 and the terminal plate 620 from each other. Such an insulator 630 may be manufactured with a resin such as polypropylene (PP) and polyethylene (PE).

The insulator 630 may be formed in a disk shape having an insertion hole 631 formed in a center thereof, similar to the cap plate 610. The bump portion 621 of the terminal plate 620 may be disposed to pass through the insertion hole 631 of the insulator 630 and the insertion hole 610a of the cap plate 610 such that the first lead tab 711 is attached to the bump portion 621. An outer diameter of the insulator 630 may have the same or similar size as an outer diameter of the terminal plate 620. The cap plate 610 may have an outer diameter large than those of the insulator 630 and the terminal plate 620. A diameter of the insertion hole 631 of the insulator 630 may have the same or similar size of a diameter of the insertion hole 610a of the cap plate 610.

The insulator 630 may be attached to the cap plate 610 and the terminal plate 620 by a thermal setting method including pressurizing, while heating, the cap plate 610 and the terminal plate 620, and the insulator 630 is disposed between the cap plate 610 and the terminal plate 620.

An insulating washer (not illustrated) may be disposed between the cap plate 610 and the first lead tab 711 to insulate the cap plate 610 and the first lead tab 711 from each other. An insulating sheet 740 may be disposed on an upper portion of the electrode assembly 700 to insulate the upper portion of the electrode assembly 700 and the first lead tab 711 from each other.

The secondary battery described with reference to FIG. 26 may be a coin type or button type battery. However, the secondary battery of the present disclosure is not limited thereto and may have other types, shapes, or configurations of secondary batteries (for example, cylindrical batteries). FIG. 26 illustrates that the first lead tab protrudes upwardly to be connected to the cap assembly, and the second lead tab protrudes downwardly to be connected to the case, but the present disclosure is not limited thereto and may be configured such that both of the first lead tab and the second lead tab protrude upwardly to be connected to the cap assembly and the case, respectively.

The case body 500 may have the first binding surface 510 formed along a circumference of one opened side surface, and the cap plate 610 of the case cover 600 bound to the one opened side surface of the case body 500 may have the second binding surface 611 formed along a circumference of the case cover such that the second binding surface 611 is bound to the first binding surface. In some embodiments, the first binding surface 510 of the case body 500 and the second binding surface 611 of the cap plate 610 may be bound to each other by welding, and the first binding surface 510 of the case body 500 and the second binding surface 611 of the cap plate 610 may be stacked together. When at least a part of the first binding surface 510 and the second binding surface 611 are inclined, the first binding surface 510 and the second binding surface 611 may be in contact with each other sufficiently so that desirable welding characteristics can be achieved during welding.

Further, shapes of the first binding surface and the second binding surface may be configured as those of embodiments described with reference to FIGS. 2 to 25.

Although the present disclosure has been described with reference to embodiments and drawings illustrating aspects thereof, the present disclosure is not limited thereto. Various modifications and variations can be made by a person skilled in the art to which the present disclosure belongs.

### DESCRIPTION OF SOME REFERENCE SYMBOLS

101, 102: Secondary battery
200a, 500: Case body
210 to 280, 510: First binding surface
300a, 600: Case cover
310 to 380, 611: Second binding surface
400, 700: Electrode assembly

What is claimed is:

1. A secondary battery comprising:
an electrode assembly including a first electrode, a second electrode, and a separator;
a case body accommodating the electrode assembly and including a first binding surface formed along a circumference of an opened side surface; and
a case cover bound to the opened side surface of the case body and including a second binding surface formed along a circumference of the case cover, with the second binding surface bound to the first binding surface,
wherein at least a part of the first binding surface and the second binding surface are inclined.

2. The secondary battery as claimed in claim 1, wherein the first binding surface includes a first inclined surface inclined at a predetermined angle with respect to a bottom surface of the case body in a first direction parallel to the case cover, and
wherein the second binding surface includes a second inclined surface formed with a same angle and a same size as those of the first inclined surface.

3. The secondary battery as claimed in claim 2, wherein an angle of the first inclined surface is more than 0 degrees and less than or equal to 60 degrees with respect to the bottom surface of the case body in the first direction.

4. The secondary battery as claimed in claim 2, wherein the first inclined surface is convex or concave, and
wherein the second inclined surface is of a shape corresponding to the first inclined surface so that the second inclined surface is in contact with the first inclined surface.

5. The secondary battery as claimed in claim 2, wherein the first binding surface includes a first horizontal surface parallel to the first direction, the first inclined surface extends toward the bottom surface of the case body from the first horizontal surface, and the second binding surface includes the second inclined surface, which is in contact with the first inclined surface.

6. The secondary battery as claimed in claim 5, wherein a length of the first horizontal surface is 1% to 10% of a thickness of the case body.

7. The secondary battery as claimed in claim 2, wherein the first binding surface includes:
a first outer horizontal surface parallel to the first direction; and
a first inner horizontal surface, which extends parallel to the first direction from the first inclined surface and on which an inner circumferential surface of the case cover settles, and
wherein the first inclined surface extends toward the bottom surface of the case body from the first outer horizontal surface, and the second binding surface includes the second inclined surface, which is in contact with the first inclined surface.

8. The secondary battery as claimed in claim 7, wherein a length of the first outer horizontal surface is 1% to 10% of a thickness of the case body, and a length of the first inner horizontal surface is 10% to 20% of the thickness of the case body.

9. The secondary battery as claimed in claim 2, wherein the first binding surface includes:
a first outer horizontal surface parallel to the first direction;
a first vertical surface extending in a direction orthogonal to the first outer horizontal surface; and
a first inner horizontal surface, which extends parallel to the first direction from the first inclined surface and on which an inner circumferential surface of the case cover settles,
wherein the first inclined surface extends toward the bottom surface of the case body from the first vertical surface, the second binding surface includes a second vertical surface in contact with the first vertical surface, and the second inclined surface extends from the second vertical surface and is in contact with the first inclined surface.

10. The secondary battery as claimed in claim 9, wherein a length of the first outer horizontal surface is 1% to 10% of a thickness of the case body, a length of the first vertical surface is 1% to 20% of a thickness of the case cover, and a length of the first inner horizontal surface is 10% to 20% of the thickness of the case body.

11. The secondary battery as claimed in claim 2, wherein the second binding surface includes a second vertical surface orthogonal to the first direction, the second inclined surface extends toward the bottom surface of the case body from the second vertical surface, and the first inclined surface is in contact with the second inclined surface.

12. The secondary battery as claimed in claim 11, wherein a length of the second vertical surface is 1% to 20% of a thickness of the case cover.

13. The secondary battery as claimed in claim 2, wherein the second binding surface includes a second vertical surface orthogonal to the first direction, the second vertical surface extends toward the bottom surface of the case body from the second vertical surface, the first inclined surface is in contact with the second inclined surface, and the first binding surface includes a first horizontal surface, which extends parallel to the first direction from the first inclined surface and on which an inner circumferential surface of the case cover settles.

14. The secondary battery as claimed in claim 13, wherein a length of the second vertical surface is 1% to 20% of a thickness of the case cover, and a length of the first horizontal surface is 10% to 20% of a thickness of the case body.

15. The secondary battery as claimed in claim 2, wherein the second binding surface includes:
a second vertical surface orthogonal to the first direction; and
a second horizontal surface extending parallel to the first direction from the second vertical surface,
wherein the second inclined surface extends toward the bottom surface of the case body from the second horizontal surface,
wherein the first binding surface includes:
a first outer horizontal surface parallel to the first direction and in contact with the second horizontal surface; and
a first inner horizontal surface, which extends parallel to the first direction from the first inclined surface and on which an inner circumferential surface of the case cover settles, and
wherein the first inclined surface extends toward the bottom surface of the case body from the first outer horizontal surface and is in contact with the second inclined surface.

16. The secondary battery as claimed in claim 15, wherein a length of the second vertical surface is 1% to 20% of a thickness of the case cover, a length of the first outer horizontal surface is 1% to 10% of a thickness of the case body, and a length of the first inner horizontal surface is 10% to 20% of the thickness of the case body.

17. The secondary battery as claimed in claim 2, wherein the second binding surface includes a second vertical surface orthogonal to the first direction,
wherein the second inclined surface extends toward the bottom surface of the case body from the second vertical surface,
wherein the first binding surface includes a first horizontal surface parallel to the first direction, and
wherein the first inclined surface extends toward the bottom surface of the case body from the first horizontal surface and is in contact with the second inclined surface.

18. The secondary battery as claimed in claim 17, wherein a length of the second vertical surface is 1% to 20% of a thickness of the case cover, and a length of the first horizontal surface is 1% to 10% of a thickness of the case body.

19. The secondary battery as claimed in claim 2, wherein the second binding surface includes a second vertical surface orthogonal to the first direction,
wherein the second inclined surface extends toward the bottom surface of the case body from the second vertical surface,
wherein the first binding surface includes:
a first outer horizontal surface parallel to the first direction; and
a first inner horizontal surface, which extends parallel to the first direction from the first inclined surface and on which an inner circumferential surface of the case cover settles, and
wherein the first inclined surface extends toward the bottom surface of the case body from the first outer horizontal surface and is tightly in contact with the second inclined surface.

20. The secondary battery as claimed in claim 19, wherein a length of the second vertical surface is 1% to 20% of a thickness of the case cover, a length of the first outer horizontal surface is 1% to 10% of a thickness of the case body, and a length of the first inner horizontal surface is 10% to 20% of the thickness of the case body.
